(19) United States
(12) Patent Application Publication
(10) Pub. No.: US 2013/0140414 A1
(43) Pub. Date: Jun. 6, 2013

(54) MAGNETIC MUD FLAP ATTACHMENT DEVICE

(71) Applicant: Ronald Ivan Copeman, Regina (CA)

(72) Inventor: Ronald Ivan Copeman, Regina (CA)

(21) Appl. No.: 13/482,711

(22) Filed: May 29, 2012

(30) Foreign Application Priority Data
Dec. 2, 2011 (CA) 2760322

(51) Int. Cl. B60R 11/00; B23P 11/00

(52) U.S. Cl. 248/206.5; 29/525.08

(57) ABSTRACT

The present invention seeks to provide an attachment device for vehicle mud flaps, wherein magnetic attachment means are employed to enable rapid replacement of damaged mud flaps without the need for tools.

### FIELD OF THE INVENTION

The present invention relates to mud flaps for vehicles, and more particularly to attachment devices for attaching mud flaps to vehicles.

### BACKGROUND OF THE INVENTION

It is well known that vehicles of various types employ mud flaps behind and adjacent the wheels of the vehicle, the mud flaps serving to reduce or eliminate the amount of spray from wet or snowy road cover and also the amount of rocks and other road debris that would otherwise be thrown backwards by the vehicle wheels.

It is conventional to attach a mud flap to a vehicle by means of bolts which hold the mud flap in place. However, mud flaps can become damaged, particularly on vehicles that are engaged in long-distance travel on a regular basis. When the mud flaps become damaged, they cease to provide the benefits for which they were designed. While it would therefore be preferable to immediately replace a damaged mud flap, the time required and the need for particular tools may cause a driver to withhold replacement of the mud flap despite the negative consequences.

There have been attempts to provide for replaceable mud flaps through the use of attachment assemblies. For example, U.S. Pat. No. 6,527,288 to Abercrombie teaches clamping plates for retaining a mud flap, the plates held together using wing nuts or cotter pins, and U.S. Pat. No. 3,684,312 to Evans teaches a clamp that employs laterally-spaced bolts. While these and other attachment devices do attempt to provide quicker replacement of mud flaps, they still suffer from disadvantages. For example, they employ small parts such as nuts that can be lost during transit or even misplaced while attempting to replace the mud flap, rendering the attachment device useless. Also, some of the prior art devices may still require tools in order to loosen and tighten the fastening means employed, particularly given the risk of losing small parts during transit if they have not been sufficiently tightened.

What is needed, therefore, is a device to retain a mud flap in position without the use of small parts that can be easily lost or misplaced, and to allow for rapid replacement of damaged mud flaps without the use of tools.

### SUMMARY OF THE INVENTION

The present invention therefore seeks to provide an attachment device that employs magnetic attraction between clamping members.

According to a first aspect of the present invention there is provided a magnetic mud flap attachment device for attaching a mud flap to a vehicle, the attachment device comprising:
a first member comprising:
   mounting means for mounting the first member on the vehicle; and
   at least one protuberance configured to receive the mud flap thereon; and
a second member comprising magnetic attraction means for magnetic attachment to the first member;
   wherein the first and second members are configured to hold the mud flap therebetween when the second member is magnetically attached to the first member.

According to a second aspect of the present invention there is provided a method for removably securing a mud flap to a vehicle, the method comprising:
(a) providing a first member having mounting means and at least one protuberance configured to receive the mud flap thereon;
(b) mounting the first member on the vehicle using the mounting means;
(c) positioning the mud flap on the at least one protuberance;
(d) providing a second member having magnetic attraction means for magnetic attachment to the first member;
(e) installing the second member against the mud flap such that the mud flap is secured between the first member and the second member; and
(f) allowing the magnetic attraction means to magnetically attach the first and second members and hold the mud flap therebetween.

In exemplary embodiments of the present invention, the first member is a plate having opposed first and second surfaces, the mounting means comprising at least two bolts extending from the first surface of the first member and, preferably, the at least one protuberance is at least two metallic posts extending from the second surface of the first member, wherein each post and each bolt is of unitary construction and extends through an aperture in the first member. The magnetic attraction means preferably comprise a magnetic surface of the second member, the magnetic surface of the second member configured to mate with the second surface of the first member, and the at least one protuberance is preferably at least one metallic post and the magnetic surface of the second member is preferably configured for magnetic attachment to the at least one metallic post. Most preferably, the magnetic surface of the second member comprises discrete magnetized contact surfaces configured to contact each metallic post, and the magnetized contact surfaces may be magnetic plugs recessed within the magnetic surface and flush therewith.

In further exemplary embodiments of the present invention, the attachment device further comprises a hinged connector for connecting the first and second members, wherein the hinged connector is disposed at either an upper or lateral edge of the first and second members. In some exemplary embodiments of the present invention, the attachment device further comprises at least one lateral magnetic member mounted on one of the first or second members for disposition therebetween when the second member is magnetically attached to the first member, configured so as to magnetically attach the second member to the first member while allowing presence of the mud flap between the first and second members but disallowing the mud flap to become dislodged from the at least one protuberance, and may comprise two lateral magnetic members spaced apart from one another and disposed laterally of the magnetic attraction means.

A detailed description of exemplary embodiments of the present invention is given in the following. It is to be understood, however, that the invention is not to be construed as being limited to these embodiments.

### BRIEF DESCRIPTION OF THE DRAWINGS

In the accompanying drawings, which illustrate exemplary embodiments of the present invention:

FIG. 1 is a front perspective view of an embodiment of an attachment device in accordance with the present invention;

FIG. 2 is a side elevation view of a hinged embodiment of an attachment device in accordance with the present invention, in an opened position;

FIG. 3 is a side elevation view of the embodiment of FIG. 2 in a closed position;

FIGS. 4 is a side elevation view of the embodiment of FIG. 2 with a mud flap in place on the metallic posts, the attachment device in an opened position;

FIG. 5 is a side elevation view of the embodiment of FIG. 2 with a mud flap in place on the metallic posts, the attachment device in a closed position; and

FIG. 6 is a front perspective view of an alternative embodiment of the present invention, illustrating the presence of lateral magnets.

Preferred embodiments of the present invention will now be described with reference to the accompanying drawings.

### DETAILED DESCRIPTION OF EXEMPLARY EMBODIMENTS

Referring now to the accompanying drawings, embodiments of attachment devices according the present invention are illustrated.

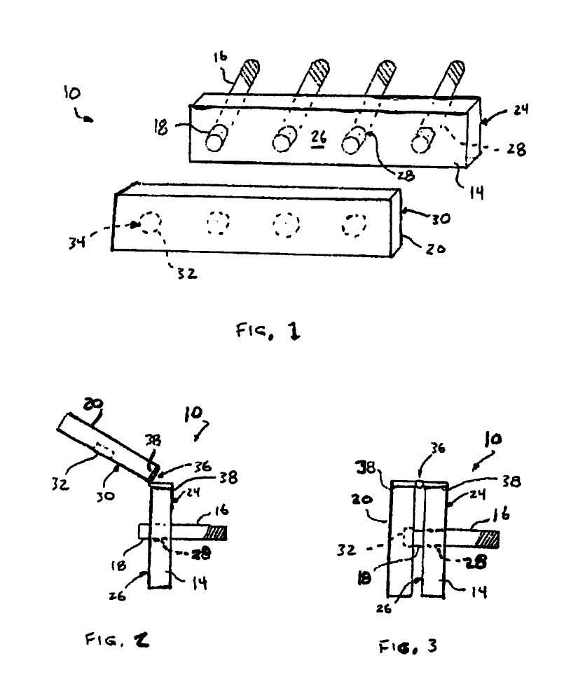

Referring now in detail to FIG. 1, an attachment device 10 according to the present invention is illustrated. The attachment device 10 comprises two opposed plates, a first plate 14 and a second plate 20. The first plate 14 comprises four apertures 28, which in the illustrated embodiment are simple holes drilled through or otherwise formed in the first plate 14, sized to receive metallic rods. The metallic rods, when inserted through the apertures 28 as shown in FIG. 1, have a first end comprising a protuberance or post 18 and a second and opposite end comprising mounting means 16, the mounting means 16 extending outwardly from a first surface 24 of the first plate 14 and the posts 18 extending outwardly from a second surface 26 of the first plate 14. Each metallic rod is inserted into an aperture 28 and can be welded in place or secured in any other manner commonly known to one skilled in the art. While each paired post 18 and mounting means 16 are illustrated as of unitary construction, it will be obvious to one skilled in the art that the two could be formed separately and mounted on opposite faces of the first plate 14. The posts 18 are designed to extend outwardly from the second surface 26 approximately ½ inch, but they must at least be of sufficient extension to receive and support a mud flap during use. The mounting means 16 are shown as threaded bolt ends, which would be employed in a conventional manner to attach the first plate 14 to the vehicle (not shown). Using the mounting means 16, the first plate 14 is intended to be attached to the vehicle and not removed, although it could be removed if the device as a whole were damaged or otherwise needed to be replaced.

The second plate 20 comprises magnetic attraction means for attracting the ends of the posts 18. In the illustrated embodiment, which shows the second plate 20 from the back, the magnetic attraction means are located on a magnetic surface 30 of the second plate 20 and comprise discrete magnetized contact surfaces or plugs 32. The plugs 32 are magnets that are seated within recessed holes 34, and in the exemplary embodiment the plugs 32 are flush with the magnetic surface 30.

The posts 18 of the first plate 14 and the plugs 32 of the second plate 20 are positioned and configured to meet when the first and second plates 14, 20 are brought into close proximity with the second surface 26 of the first plate 14 facing the magnetic surface 30 of the second plate 20. When the posts 18—which are metallic—come into contact with the magnetic plugs 32, a magnetic attraction is generated and the mud flap can be retained on the posts 18 and held between the plates 14, 20. It will be obvious to one skilled in the art that the magnetic attraction must be sufficient to keep the posts 18 and corresponding plugs 32 in contact during normal usage but capable of disengagement when a user wishes to replace a damaged mud flap, and one skilled in the art could easily arrive at various magnetic plug types that would provide adequate attraction.

Turning now to FIGS. 2 and 3, a hinged embodiment of the attachment device 10 is illustrated. Whereas FIG. 1 illustrated an embodiment where the first and second plates 14, 20 are separate and only connected through the magnetic attraction between the posts 18 and plugs 32, the embodiment of FIGS. 2 and 3 has the plates 14, 20 connected by means of a hinge 36. Although the hinge is shown as being positioned along the upper edges 38 of the plates 14, 20, it would be obvious to one skilled in the art that the hinge connection could be along a lateral edge, as well, although this is not shown. With the hinge 36 connecting the upper edges 38 of the plates 14, 20, the second plate 20 can be rotated upwardly and away from the second surface 26 of the first plate 14, as is shown in FIG. 2; this is the open orientation that would allow a user to position a mud flap on the posts 18. FIG. 3 illustrates a closed orientation, with the second plate 20 rotated downwardly and toward the second surface 26 of the first plate 14, the posts 18 in contact with the plugs 32, which closed orientation would be used to retain a mud flap between the two plates 14, 20. Note in FIG. 3 that the hinge 36 allows for a spacing between the plates 14, 20 generally equivalent to the spacing introduced by the intervening presence of the posts 18—this provides a consistent gap between the plates 14, 20 to enable an appropriate space to house the mud flap.

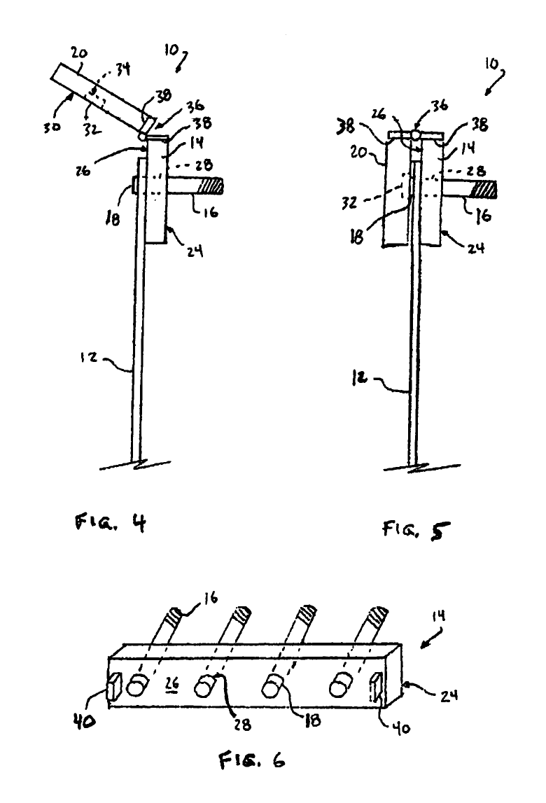

FIGS. 4 and 5 illustrate the embodiment of FIGS. 2 and 3 but with the mud flap in position. As can be seen in FIG. 4, the second plate 20 is rotated upwardly and away from the second surface 26 of the first plate 14, which exposes the posts 18 and allows a user to remove a damaged mud flap and position a replacement mud flap 12 over the posts 18. Once the replacement mud flap 12 is in position on the posts 18, the second plate 20 can be rotated downwardly and toward the second surface 26 of the first plate 14, as is illustrated in FIG. 5. In the closed position shown in FIG. 5, the posts 18 are held in magnetic attraction to the plugs 32, which retains the replacement mud flap 12 in the gap between the first and second plates 14, 20.

FIG. 6 illustrates a further exemplary embodiment of the present invention. In this further embodiment, lateral magnetic members 40 are provided on the second surface 26 of the first plate 14. These lateral magnetic members 40 could be incorporated to provide additional magnetic attraction between the plates 14, 20 and help ensure retention of the mud flap during vehicle use. As would be clear to one skilled in the art, the lateral magnetic members 40 could alternatively be positioned on the magnetic surface 30 of the second plate 20, or could even comprise paired attractive members on each of the first and second plates 14, 20. Other variations would be obvious to one skilled in the art.

As can be readily seen, then, the attachment device of the present invention presents significant advantages over the prior art. It can retain a mud flap in position without the use of small parts that can be easily lost or misplaced, and it allows for rapid replacement of damaged mud flaps without the use of tools.

The foregoing is considered as illustrative only of the principles of the invention. Thus, while certain aspects and embodiments of the invention have been described, these have been presented by way of example only and are not intended to limit the scope of the invention. Indeed, the invention described herein may be embodied in a variety of other forms without departing from the spirit of the invention, which invention is defined solely by the claims below.

1. A magnetic mud flap attachment device for attaching a mud flap to a vehicle, the attachment device comprising:
a first member comprising:
mounting means for mounting the first member on the vehicle; and
at least one protuberance configured to receive the mud flap thereon;
a second member; and
magnetic attraction means for magnetic attachment of the second member to the first member;
wherein the first and second members are configured to hold the mud flap therebetween when the second member is magnetically attached to the first member.

2. The attachment device of claim 1 wherein the first member is a plate having opposed first and second surfaces, the mounting means comprising at least two bolts extending from the first surface of the first member.

3. The attachment device of claim 2 wherein the at least one protuberance is at least two metallic posts extending from the second surface of the first member.

4. The attachment device of claim 3 wherein each post and each bolt is of unitary construction and extends through an aperture in the first member.

5. The attachment device of claim 2 wherein the magnetic attraction means comprise a magnetic surface of the second member, the magnetic surface of the second member configured to mate with the second surface of the first member.

6. The attachment device of claim 5 wherein the at least one protuberance is at least one metallic post and the magnetic surface of the second member is configured for magnetic attachment to the at least one metallic post.

7. The attachment device of claim 6 wherein the magnetic surface of the second member comprises discrete magnetized contact surfaces configured to contact each metallic post.

8. The attachment device of claim 7 wherein the magnetized contact surfaces are magnetic plugs recessed within the magnetic surface and flush therewith.

9. The attachment device of claim 1 further comprising a hinged connector for connecting the first and second members.

10. The attachment device of claim 9 wherein the hinged connector is disposed at an upper edge of the first and second members.

11. The attachment device of claim 9 wherein the hinged connector is disposed at a lateral edge of the first and second members.

12. The attachment device of claim 1 further comprising at least one lateral magnetic member mounted on one of the first or second members for disposition therebetween when the second member is magnetically attached to the first member, configured so as to magnetically attach the second member to the first member while allowing presence of the mud flap between the first and second members but disallowing the mud flap to become dislodged from the at least one protuberance.

13. The attachment device of claim 12 comprising two lateral magnetic members spaced apart from one another and disposed laterally of the magnetic attraction means.

14. A method for removably securing a mud flap to a vehicle, the method comprising:
(a) providing a first member having mounting means and at least one protuberance configured to receive the mud flap thereon, a second member and magnetic attraction means for magnetic attachment of the second member to the first member;
(b) mounting the first member on the vehicle using the mounting means;
(c) positioning the mud flap on the at least one protuberance;
(d) installing the second member against the mud flap such that the mud flap is secured between the first member and the second member; and
(e) allowing the magnetic attraction means to magnetically attach the first and second members and hold the mud flap therebetween.

15. The method of claim 14 wherein the first and second members are connected by means of a hinged connector, step d of the method further comprising rotating the second member at the hinged connector so as to pivot the second member into position against the mud flap.
